(19) United States
(12) Patent Application Publication
(10) Pub. No.: US 2011/0137507 A1
(43) Pub. Date: Jun. 9, 2011

(54) SYSTEM HAVING CRASH UNLOCK ALGORITHM

(75) Inventor: Kwang Cheol Sinh, Hwaseong (KR)

(73) Assignees: HYUNDAI MOTOR COMPANY, Seoul (KR); KIA MOTORS CORPORATION, Seoul (KR)

(21) Appl. No.: 12/861,951

(22) Filed: Aug. 24, 2010

(30) Foreign Application Priority Data
Dec. 4, 2009 (KR) 10-2009-0120172

(51) Int. Cl. G06F 7/00; B60R 21/0136

(52) U.S. Cl. 701/29

(57) ABSTRACT

The present invention features a system having a door unlock algorithm, which includes an ACU (Airbag Control Unit) which measures an acceleration of vehicle; an algorithm which determines by comparing a value measured in the ACU with a preset value; and a BCM (Body Control Module) to which a signal which is determined through the algorithm is sent

### CROSS-REFERENCE TO RELATED APPLICATION

This application claims under 35 U.S.C. §119(a) the benefit of Korean patent application number 10-2009-0120172, filed on Dec. 4, 2009, which is incorporated herein by reference in its entirety.

### BACKGROUND OF THE INVENTION

The present invention relates, generally, to a system having a crash unlock algorithm.

Presently, an auto door lock apparatus used in most vehicles automatically locks each door as a Body Control Module (BCM) sends a signal when the vehicle travels over a given speed.

Accordingly, the auto door lock apparatus of the vehicle prevents an accident, for example, where the door is opened due to a mistake or the carelessness of a passenger in a high-speed driving state.

However, if the vehicle is in a collision, contrary to above case, the door is unlocked so that people outside the vehicle may rescue the injured passenger inside of vehicle.

For example, as shown in FIG. 1, in a typical door unlock system, in case a crash accident of the air bag deploy level occurs in an airbag mount vehicle, an Airbag Control Unit (ACU) deploys an airbag and pretensioner, outputs a Crash Output and send the signal to the BCM. The BCM recognizes the Crash Output and operates an Actuator, and if Relay operates, power is supplied from the battery to unlock door.

Accordingly, in the conventional system, for example as shown in FIG. 2, if a crash occurs, the ACU immediately measures the acceleration of vehicle. Further, if the acceleration value is a set value or more, a door unlock signal is immediately sent to the BCM.

However, in the conventional door unlock system if a vehicle does not contain an airbag in the side of vehicle, the air bag deploy determination is not performed. Accordingly, the ACU is unable to transmit the door unlock signal. Here, a separate mechanical sensor or electronic sensor is suitably applied to transmit the crash signal to the BCM, but it has to consider installation cost and installation space.

The above information disclosed in this the Background section is only for enhancement of understanding of the background of the invention and therefore it may contain information that does not form the prior art that is already known in this country to a person of ordinary skill in the art.

### SUMMARY OF THE INVENTION

The present invention provides a system having a crash unlock algorithm which preferably includes an Airbag Control Unit (ACU) which measures the acceleration of a vehicle, an algorithm which suitably determines and compares a value measured in the ACU with a preset value, and a Body Control Module (BCM) to which a signal which is determined through the algorithm is sent.

In accordance with a preferred embodiment of the present invention, a system having a door unlock algorithm includes an ACU which suitably measures acceleration of vehicle; an algorithm which suitably determines by comparing a value measured in the ACU with a preset value; and a BCM to which a signal which is suitably determined through the algorithm is sent.

Preferably, in certain exemplary embodiments, the ACU uses a dual acceleration sensor data. In further preferred embodiments, in the system having a door unlock algorithm, in certain examples of being equipped with a side airbag, a side crash algorithm signal is suitably transmitted to unlock a door when the side air bag is deployed, whereas, in certain examples of not being equipped with the side airbag, a side crash unlock algorithm signal is suitably transmitted to unlock the door. In preferred embodiments of being suitably equipped with the side airbag, a side impact sensor is preferably used to deploy the side airbag. In certain preferred embodiments, the algorithm includes a rollover algorithm, a front crash algorithm, a side crash algorithm and a side crash unlock algorithm. In further preferred embodiments, after the algorithm operates, in examples of being lower than a reset number for a given time, a side crash unlock algorithm is reset.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum).

As referred to herein, a hybrid vehicle is a vehicle that has two or more sources of power, for example both gasoline-powered and electric-powered.

The above features and advantages of the present invention will be apparent from or are set forth in more detail in the accompanying drawings, which are incorporated in and form a part of this specification, and the following Detailed Description, which together serve to explain by way of example the principles of the present invention.

### BRIEF DESCRIPTION OF THE DRAWINGS

The above and other features of the present invention will now be described in detail with reference to certain exemplary embodiments thereof illustrated by the accompanying drawings which are given hereinafter by way of illustration only, and thus are not limitative of the present invention, and wherein:

FIG. 1 illustrates a typical door lock algorithm;

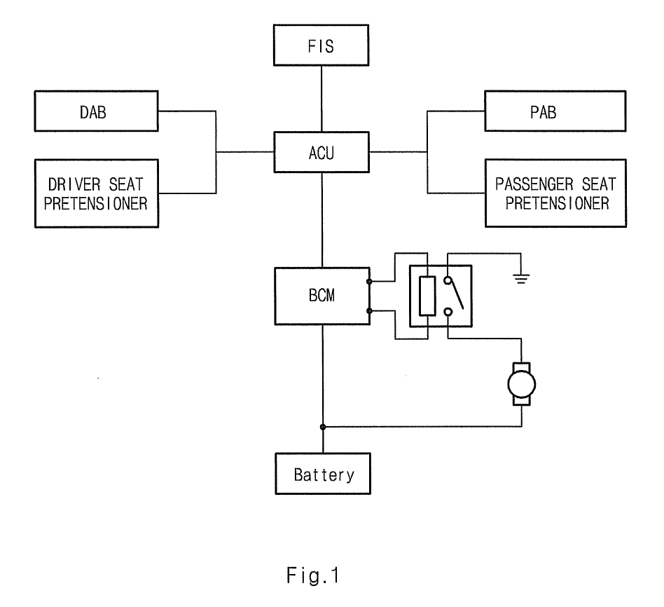

FIG. 2 is a flowchart illustrating a typical door lock control method;

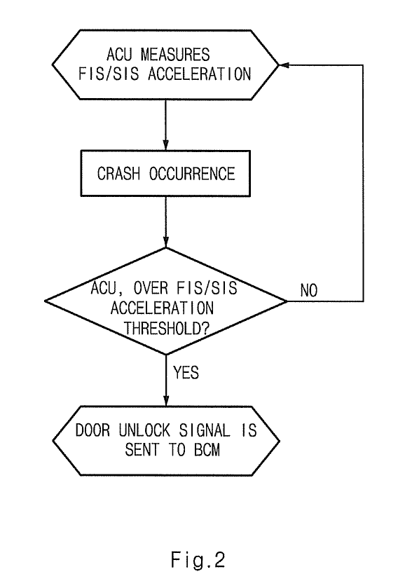

FIG. 3 is a flowchart illustrating a door lock algorithm/logic according to preferred embodiments of the present invention; and

FIG. 4 illustrates a door unlock algorithm/logic in crash according to preferred embodiment of the present invention.

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

### DETAILED DESCRIPTION OF THE EMBODIMENTS

In a preferred aspect, the present invention features a system having a door unlock algorithm, the system comprising an ACU (Airbag Control Unit)which measures an acceleration of vehicle, an algorithm which determines by comparing a value measured in the ACU with a preset value, and a BCM (Body Control Module) to which a signal which is determined through the algorithm is sent.

Hereinafter, exemplary embodiments of the present invention will be described in detail with reference to the attached drawings.

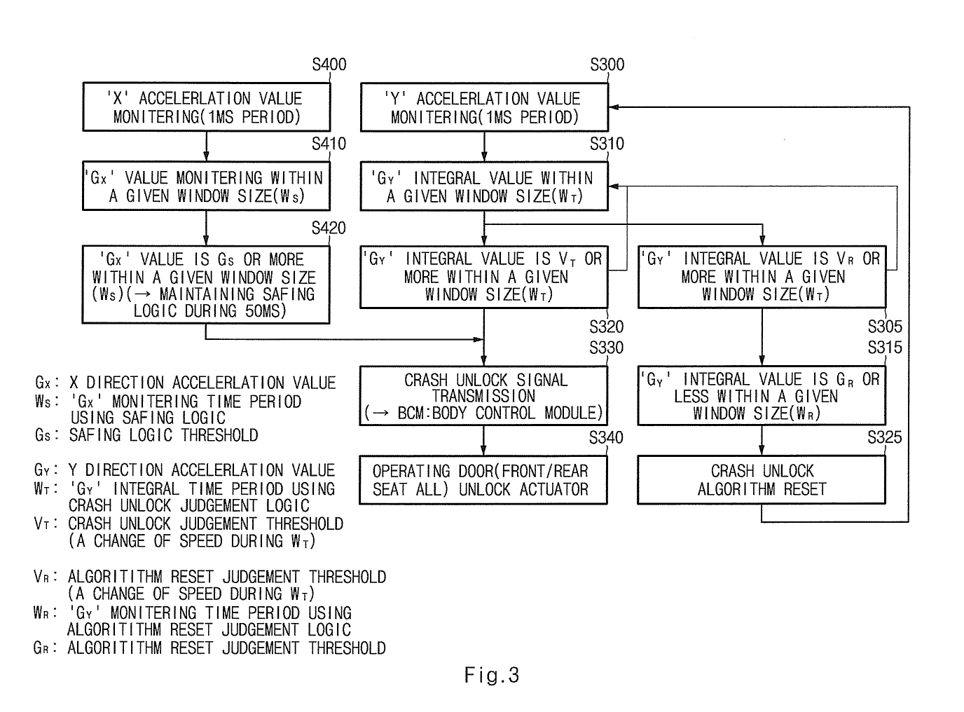

FIG. 3 is a flowchart illustrating a door lock algorithm/logic according to preferred embodiments of the present invention.

In preferred exemplary embodiments, and Referring to FIG. 3, in case vehicle is equipped with a side airbag, it applies a side impact sensor to unlock door after deploying the side airbag. On the other hand, in case vehicle is not equipped with a side airbag, it does not apply a side impact sensor, so that an airbag control unit (ACU) uses the inside ‘Y’ acceleration sensor unit to measure ‘Y’ acceleration (‘G_{Y}’), thereby determining the transmission of door unlock in crash. At this time, ‘Y’ means longitudinal direction and ‘G_{Y}’ means ‘Y’ accelerlation.

Here, in the door unlock algorithm of ACU, it is determined whether a change of speed ‘v’ value that means integral value as time of ‘G_{Y}’ value is a threshold value V_{T} or more (S320) Here, the threshold value V_{T} means an integral value within a window section. Here, a widow section means the time for calculating V value and window section and V_{T} mean values through a real test for car.

After integral value of ‘G_{Y}’ during a given time is higher than a reset number, during a given time ‘G_{Y}’ value is lower than a threshold value (G_{R}) (S315), a side crash unlock algorithm is reset (S325)

After the side crash unlock algorithm is reset, ‘Y’ acceleration is measured so that the algorithm operates again when it is a given ‘G_{Y}’ value or more (S300)

On the other hand, in case a given ‘G_{Y}’ integral value is a threshold value V_{T} or more, a crash door unlock signal is transmitted (S330)

After getting safing logic for preventing from malfunction of door unlock, a crash door unlock signal is transmitted (S400˜S420)

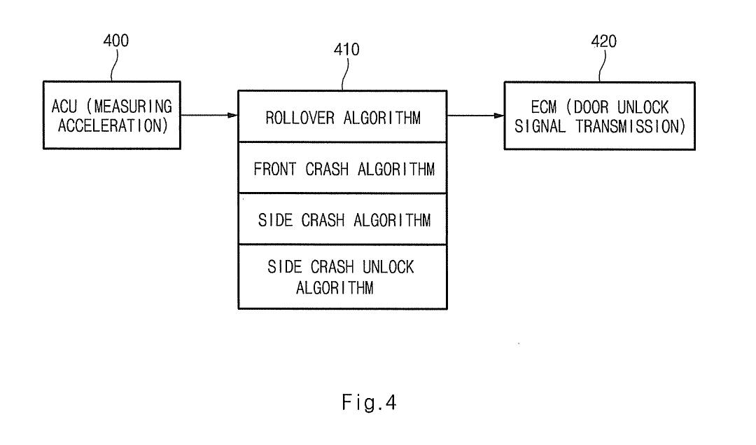

After the crash door unlock signal is transmitted, an actuator which can unlock all doors is operated (S340)
According to further preferred embodiments, and as shown in FIG. 4, for example, FIG. 4 illustrates a door unlock algorithm/logic in crash.

Referring to FIG. 4, for example, if a vehicle crash occurs, an airbag control unit (ACU) 400 immediately measures the acceleration of vehicle. In case the measured value is a set value or more, an algorithm 410 is suitably operated. Preferably, the algorithm includes a roll over algorithm, a front crash algorithm, a side crash algorithm and a side crash unlock algorithm. In further preferred embodiments, a signal determined through those algorithms rotates is immediately sent to a body control module (BCM) 420 to unlock door.

As described herein, the present invention relates to an apparatus to automatically unlock the door of vehicle when a side crash occurs in a vehicle which is not equipped with a side airbag. According to preferred embodiments of the present invention as described herein, in examples of driving over a given speed, when a side airbag is not suitably equipped in a state where a door of the vehicle is automatically locked, a crash unlock signal is suitably generated by using a newly added side crash unlock algorithm to unlock vehicle door.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A system having a door unlock algorithm, the system comprising:
an ACU (Airbag Control Unit)which measures an acceleration of vehicle;
an algorithm which determines by comparing a value measured in the ACU with a preset value; and
a BCM (Body Control Module) to which a signal which is determined through the algorithm is sent.

2. The system of claim 1, wherein the ACU (Airbag Control Unit) uses a dual acceleration sensor data.

3. The system of claim 1, wherein, in the system having a door unlock algorithm, in case of being equipped with a side airbag, a side crash algorithm signal is transmitted to unlock a door when the side air bag is deployed, whereas, in case of not being equipped with the side airbag, a side crash unlock algorithm signal is transmitted to unlock the door.

4. The system of claim 3, wherein, in case of being equipped with the side airbag, a side impact sensor is used to deploy the side airbag.

5. The system of claim 1, wherein the algorithm includes a rollover algorithm, a front crash algorithm, a side crash algorithm and a side crash unlock algorithm.

6. The system of claim 1, wherein, after the algorithm operates, in case of being lower than a reset number for a given time, a side crash unlock algorithm is reset.

7. The system of claim 1, wherein when the system comprises a side airbag, a side crash algorithm signal is transmitted to unlock a door when the side air bag is deployed.

8. The system of claim 1, wherein when the system does not comprise an airbag, a side crash unlock algorithm signal is transmitted to unlock the door.

9. The system of claim 7, wherein a side impact sensor is used to deploy the side airbag.
